(19) United States
(12) Patent Application Publication
(10) Pub. No.: US 2015/0164115 A1
(43) Pub. Date: Jun. 18, 2015

(54) Method for Producing a Large Sized Dumpling

(71) Applicant: Dim Sum Food Co., Ltd., Gyeonggi-do (KR)

(72) Inventor: Luan Chi-Kao, Seoul (KR)

(21) Appl. No.: 14/252,006

(22) Filed: Apr. 14, 2014

(30) Foreign Application Priority Data
Dec. 12, 2013 (KR) 10-2013-0154917

(51) Int. Cl. A23L 1/16

(52) U.S. Cl. CPC A23L 1/16; A23L 1/1606

(57) ABSTRACT

A method for producing a large size of dumpling is disclosed. The method comprises preparing a pre-stuff for producing dumpling by putting a bun stuffing into a skin; fermenting the pre-stuff in temperature of 30 to 50° C. and in humidity of 50 to 70%; making a pre-dumpling by steaming the pre-stuff in temperature of 90 to 130° C. for 5 to 20 minutes; cooling the pre-dumpling; and freezing the pre-dumpling with rapidity below −20° C. for 60 to 180 minutes, wherein the skin comprises a wheat flour, a yeast, a pure water, a baking powder, a soy bean, a salt, a liquid prima and mixing-ingredients.

### BACKGROUND OF THE INVENTION

1. Field of the Invention

The present invention relates to a method for producing dumplings with large size, and more specifically to a method for producing dumplings containing kimchi or meat.

2. Description of the Related Art

A dumpling may consist of a skin and a bun stuffing that is enclosed by the skin, in which the skin can be made from paste of flour or buckwheat flour and the bun stuffing can be made from meat, tofu or kimchi. For producing the dumpling in a kind of eatable food, the skin and the bun stuffing should be steamed or fried. In particular, a dumpling having a bigger size than that of general dumplings may be called as a large size of dumpling. Dumpling can be made from various skins and bun stuffing with different cooking methods, and each dumpling may have similar or unique taste. And the dumpling can have different taste mainly according to ingredients of the skin or bun stuffing, or cooking method.

Korean patent publication no. 2013-0101231 discloses a method for producing a dumpling, which comprises mixing 68 wt % of salted-shredded daikon, 2.5 wt % of chives, 0.7 wt % of garlic, 0.1 wt % of ginger, 0.02 wt % of black pepper, 0.33 wt % of oligosaccharides, 0.22 wt % of perilla seed oil, 0.12 wt % of seasoning, 8 wt % of hot pepper powder and 20 wt % of pork; and inputting 35 g of bun stuffing into 15 g of dumpling skin to steam.

Korean patent registration no. 1319102 discloses a method for producing a dumpling by adding bamboo sprout, in which the method comprises making a skin; water-immersing a bamboo sprout; blanching the bamboo sprout; drying the bamboo sprout at room temperature; drying the bamboo sprout in the range of 45° C.˜75° C. for 40 to 85 minutes with heated air; making a bun stuffing using the bamboo sprout; and making dumpling with the skin and the bun stuffing. And the bun stuffing may contain at least a stuff selected from a group consisting of a tofu, a gourd, a glass noodles, a bean-sprouts, a chives and a green onion.

The known various methods for producing dumplings does not disclose processing dumplings for distributing in large bulk. In general, the dumpling can be fed on the spot, but the dumpling can be produced in bulk for distributing and being fed after cooking. In case of producing in large bulk, the unique taste needs not to be lost during storage by selecting proper stuffs and processing the skin and the bun stuffing appropriately.

A purpose of the present invention provides a method for producing dumplings in large bulk for being eaten after storing and distributing.

### SUMMARY OF THE INVENTION

In one embodiment, a method for producing a large size of dumpling is disclosed. The method comprises preparing a pre-stuff for producing dumpling by putting a bun stuffing into a skin; fermenting the pre-stuff at the temperature of 30 to 50° C. and at the humidity of 50 to 70%; making a pre-dumpling by steaming the pre-stuff at the temperature of 90 to 130° C. for 5 to 20 minutes; cooling the pre-dumpling; and freezing the pre-dumpling with rapidity below −20° C. for 60 to 180 minutes, wherein the skin comprises a wheat flour, a yeast, a pure water, a baking powder, a soy bean, a salt, a liquid prima and mixing-ingredients.

In another embodiment, the method further comprises making the wheat flour into a paste by gelatinizing-heating method.

In still another embodiment, the paste of the skin is mixed in dual stages.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart illustrating an example of process for making a large dumpling according to one embodiment of the present invention.

FIG. 2 is a flow chart illustrating an example of process for making a skin according to one embodiment of the present invention.

### DETAILED DESCRIPTION OF THE INVENTION

Exemplary embodiments of the present invention will now be described in detail.

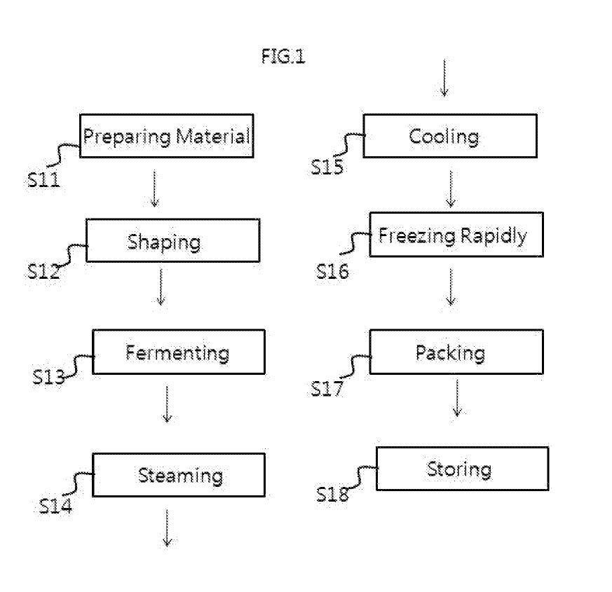

FIG. 1 is a flow chart illustrating an example of process for making a large dumpling according to one embodiment of the present invention.

Referring to FIG. 1, the method for producing a dumpling comprises preparing a pre-stuff for producing a dumpling by putting a bun stuffing into a skin; fermenting the pre-stuff at the temperature of 30 to 50° C. and at the humidity of 50 to 70%; making a pre-dumpling by steaming the pre-stuff at the temperature of 90 to 130° C. for 5 to 20 minutes; cooling the pre-dumpling; and freezing the pre-dumpling with rapidity below −20° C. for 60 to 180 minutes, wherein the skin comprises a wheat flour, a yeast, a pure water, a baking powder, a soy bean, a salt, a liquid prima and mixing-ingredients.

The large size of dumpling may be produced by preparing a skin and a bun stuffing separately and processing the above-mentioned steps after inputting the bun stuffing into the skin. The large size of dumpling according to the present invention may be produced in large bulk, for example at a factory having various facilities to store for distributing, and provides for sale at the market. Then, the provided dumplings can be made edible by being steamed or grilled. Therefore, the method for producing the dumpling according to the present invention may be applied to dumplings to be packed for distributing.

According to an example of the present invention, the skin may comprise 35˜45 wt % wheat flour; 0.3˜0.8 wt % of yeast; 1.0˜2.0 wt % of pure water; 0.3˜0.8 wt % of baking powder; 0.2˜0.4 wt % of soy bean; 0.15˜0.35 wt of salt; 0.10˜0.40 wt % of liquid prima; and 0.10˜0.30 wt % of ingredients such as SP

In one embodiment, the bun stuffing may comprise 8˜15 wt % of kimchi; 258˜15 wt % of pork; 8˜15 wt % of glass noodle; 5.0˜12 wt % of sliced shiitake; 3.0˜6.0 wt % of onion; 1.0˜4.0 wt % of tofu; 1.0˜4.0 dried radish; 1.0˜4.0 wt % of cabbage; 1.0˜3.0 wt % of leek; 0.2˜1.0 kimchi seasoning; 0.1˜0.4 wt % of potato starch; 0.2˜0.5 wt % of hot pepper powder; 0.5˜2.0 wt % of garlic; 0.1˜0.5 wt % of black pepper; 0.1˜0.3 wt % of soy sauce; and 0.01˜0.2 wt % of flavoring oil.

In another embodiment, the bun stuffing may comprise 15˜25 wt % of kimchi; 8˜15 wt % of glass noodle; 5.0˜12 wt % of sliced shiitake; 3.0˜6.0 wt % of onion; 1.0˜4.0 wt % of tofu; 1.0˜4.0 wt % of dried radish; 1.0˜4.0 wt % of cabbage; 1.0˜3.0 wt % of leek; 0.05˜0.2 wt % of hot pepper powder; 0.1˜0.4 wt % of potato starch; 0.5˜2.0 wt % of hot pepper flavoring oil; 0.5˜2.0 wt % of garlic; 0.1˜0.5 wt % of pepper; 0.1˜0.3 wt % of soy sauce; and 0.01˜0.2 wt % of flavoring oil.

In still another embodiment, the bun stuffing may comprise 15˜25 wt % of pork; 8˜15 wt % of glass noodle; 5.0˜12 wt % of sliced shiitake; 3.0˜6.0 wt % of onion; 1.0˜4.0 wt % of tofu; 1.0˜4.0 wt % of dried radish; 1.0˜4.0 wt % of cabbage; 1.0˜3.0 wt % of leek; 0.5˜1.2 wt % of chives; 0.1˜0.4 wt % of potato starch; 0.1˜0.4 wt % of winter-grown vegetables; 0.5˜2.0 wt % of garlic; 0.1˜0.5 wt % of pepper; 0.1˜03 wt % of soy sauce; and 0.01˜0.2 wt % of flavoring oil.

Each bun stuffing may be put into a skin to produce a kimchi dumpling, a Szechuan dumpling and a meat dumpling, respectively, and a unique taste according to the different bun stuffing may be preserved during production.

The wheat flour means a powder made from an albumen part of wheat, and is produced by a roll milling machine. The wheat flour may be produced from Korean wheat including Sonora 64 wheat, dwarf wheat or Keumkang wheat, etc. The SP is a kind of mixing ingredient, and includes an emulsifier, a sodium acetate, a malic acid, a hydroxyl propyl phosphate, a potato starch, a potassium hydrogen tartrate or a fumaric acid. And the SP may include a propylene glycol.

Various additives may be added for producing the skin, and the present invention is not limited to the illustrated embodiments. The process making the skin from the prepared stuffs will be disclosed in following.

In one embodiment, a multi-enzyme compound such as a Hemi-celluase, a lipase and the like can be added to the skin. The multi-enzyme compound may have a value of titer corresponding to xylanase, glucanase and lipase originated from aspergilus, and can hydrolyze β-glucan and animal and/or vegetable fat that may be mixed in a wheat dough. And the result of the hydrolysis including a mono-glyceride, a di-glyceride, a tri-glyceride, a fatty acid and a glycerol can improve the stability of the wheat dough and the property of the produced dumpling.

In general, the mixture for the dumpling has defect that the resilient property of the dough is insufficient and the property of extension is higher than that of breads, because of the deficiency of salt. Hence, an enzyme, an ascorbic acid or a bread improving agent can be added to the mixture of the dumpling for improving the stability.

In one embodiment of the present invention, the multi-enzyme compound may be added to the dough of the dumpling for compensating the defect of the wheat dough of the dumpling. The multi-enzyme compound may have functions improving volume, connection, mechanism and cooking tolerance. The multi-enzyme compound may be added in amount of 5 ppm˜50 ppm for a lower sugar flour, while in amount of 150˜250 ppm for a higher sugar flour. The higher sugar flour means that the amount of sugar is 5˜10 wt % to the amount of the flour. The multi-enzyme compound may be added, mixed with the flour, or be added in form of a water solution. Advantageously, a tigerzym may be substituted for the multi-enzyme compound.

In the meanwhile, a sour wheat powder may be used for producing the dumpling according to the present invention. The sour wheat powder has some acidity and unique taste in light yellowish brown color, and may be added in amount of 1˜5 wt % to that of the wheat flour. For example, the sour wheat may consist of an wheat malt, an wheat milling product and a seed culture, and may have water content below 5 wt %, about 3.3 pH and total acidity of 90 to 110. In one embodiment, the sour wheat powder may comprise 4.4 wt % of humidity, 1.8 wt % of ash, 14.1 wt % of protein, 1.4 wt % of fat, 9.09 wt % of dietary fiber and 69.2 wt % of carbohydrate. The seed culture may be a lactobacillus, an acetobacter or a yeast fungus.

The skin and bun stuffing may be prepared, at S11, as amount of skin:bun stuffing=60:20˜45 in weight and each may be weighed in the range of the above amount properly. If the skin and bun stuffing is prepared in the above-mentioned amount, at S11, then dough may be made for the skin, at S12 and the bun stuffing may be input into the skin in a predetermined shape. The dough for the skin may be made according a known manner in this art, for example the dough may be made through mechanical mixing or stirring.

After the skin is made from the dough and the bun stuffing is sealed within the skin to be a pre-stuff for the dumpling, the pre-stuff may be fermented to be a dumpling, at S13. The fermentation can proceed at 30 to 50° C. of temperature and 50 to 70% of relative humidity. The fermentation, for example, may proceed at a fermentation room for 30 to 60 minutes. And the fermented pre-stuff may be made into a pre-dumpling through being steamed, at S14.

For example, the steaming may proceed at 90 to 130° C. of temperature for 5 to 20 minutes at a steaming room that has a suitable controller to regulate the temperature with steam. After the steam process is completed, a cooling may proceed, at S15. The cooling can be, not limited to, natural cooling, but the pre-dumpling may be cooled in any method known in this art.

The dumpling according to the present invention can be made for mass production and distribution, and after distribution, the dumpling can be made eatable by being steamed or being grilled. Therefore, in cooling process, advantageously, the rate of water absorption should be controlled properly. In other words, it is necessary for the most outer part should be to be hardened faster than any other part of the pre-dumpling. For such cooling process, the pre-dumpling be cooled at 0 to 15° C. and below 30% of relative humidity firstly, then the pre-dumpling may be cooled in a natural cooling method. On the other hand, the first cooling may proceed at 0.5 to 0.9 of atmosphere. The first cooling may proceed for 5 to 10 minutes.

If the natural cooling method is completed, at S15, the rapid freezing process may proceed for storing and preserving taste of the pre-dumpling, at S16. For example, the rapid freezing may proceed below −20° C. for 60 to 240 minutes. The rapid freezing may prevent the dumpling from going to bad during distribution and at the same time may be stored in long term. Then, the frozen pre-dumpling may be packed as a predetermined amount of dumpling per box, at S17, and each box can be stored at a food depot, at S18. The dumplings can be packed and stored in any method known in this art. And the present invention cannot be limited to the method.

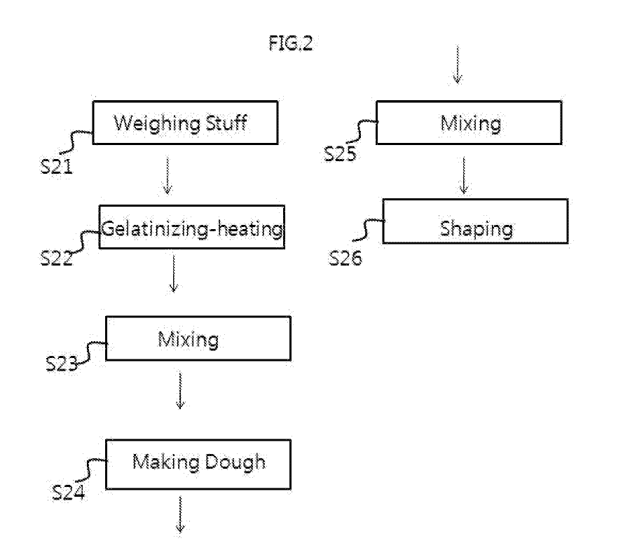

FIG. 2 is a flow chart illustrating an example of process for making a skin according to one embodiment of the present invention.

Referring to FIG. 2, the method for producing a skin of a dumpling may comprise weighing raw material, at S21; first-mixing the weighted raw material using gelatinizing-heating method, at S22; second-mixing the gelatinized material with auxiliary stuff added, at S23: making the material and stuff into a dough using a kneader, at S24; mixing the dough at least first time at S25; and shaping the mixed dough into a predetermined size and form in a food molding machine, at S26.

As above-mentioned, the skin may comprise 35˜45 wt % wheat flour; 0.3˜0.8 wt % of yeast; 1.0˜2.0 wt % of pure water; 0.3˜0.8 wt % of baking powder; 0.2˜0.4 wt % of soy bean; 0.15˜0.35 wt % of salt; 0.10˜0.40 wt % of liquid prima; and 0.10˜0.30 wt % of ingredients such as SP to the total weight of dumpling. In addition, the skin may comprise 5 to 250 ppm of multi-multi-enzyme compound and 1 to 5 wt % of sour wheat powder to the weight of wheat flour.

For producing the skin, the wheat flour may be input into the kneader for making gelatinization-heated dough. For gelatinization-heating, the reduced amount of wheat flour by 0.3 to 1.0 wt % to the total weight of the dumpling may be mixed with water. And the above-mentioned material can be input a heater and may be heated, for example, at the temperate of 80 to 100° C. in a manner double boiling. The gelatinization means that a starch powder loses crystallization to be enhanced in resolvability, and it may have advantage that the skin may be soft and the aging can be delayed. If more than or equal to 90% of the wheat flour is gelatinized by double-boiling, the yeast, the baking powder, the raw bean powder, the salt, the SP and the liquid prima may be added to the gelatinized wheat flour, at S23.

The SP may be some mixing ingredient, and the ingredient may comprise an emulsifier, a preserved agent, an anti-oxidant, a stabilizing agent, a solvent and the like. The ingredient may further comprise an acidity-regulating agent, an enzyme supplement, an vitamin C, a sodium acetate, a dextrin, a hydroxypropylphosphoric acid, a starch, a potassium hydrogen tartrate, a sodium phosphate dibasic, a fumaric acid, a glucose powder and the like. After the material and stuff are mixed suitably through a second mixing, the making dough may proceed, at S24. During making dough, it is necessary for the dough to be mixed to determine the developing degree of gluten. The dough may be made through picking, cleaning up, developing and completing, and the mixing may proceed to determine the degree of the development. The Mixing may advance as two stages, and continue for 1 to 3 minutes and 4 to 8 minutes at first stage and second stage, respectively. And the gluten may develop to the degree of 70 to 90%.

After mixing is completed at S25, the dough may put into a food molding machine to be formed with certain size, at S26. And the bun stuffing is put into the skin. As above-mentioned, the bun stuffing is put into the skin such as skin:bun stiffing=60:20 to 45 in weight percentage.

Below, there are provided with various embodiments of the method for producing the dumpling according to the present invention.

### EXAMPLES

### Example 1

Step 1: 111.23 g of kimchi; 101.1 g of pork; 118.0 g of glass noodle; 80.2 g of sliced shiitake; 44.7 g of onion; 25.3 g of tofu; 24.6 g of dried radish; 25.4 g of cabbage; 13.1 g of leek; 4.1 g of kimchi seasoning; 2.2 g of potato starch; 3.2 g of hot pepper powder; 2.5 g of pepper; 9.8 g of garlic; 2.5 g of black pepper; 1.2 g of soy sauce; and 0.6 g of flavoring oil are prepared for the bun stuffing. And 395.7 g of wheat flour; 5.3 g of yeast; 15 g of pure water; 5.0 g of baking powder; 3.3 g of soy bean; 2.8 g of salt; 2.6 g of liquid prima; and 2.0 g of SP are prepared for the skin. The prepared materials of the skin are mixed through two stage using gelatinizing-heating method, wherein the time for the first and second mixing is two and six minutes, respectively, and the development degree of gluten is 80 to 85%, and then the dough is put into a food molding machine to shape the skin.

Step 2: the bun stuffing was put into the skin and the pre-dumpling was fermented at the temperature of 40° C. and the relative humidity of 60% for 40 minutes, and then the pre-dumpling was steamed at 110° C. for about 10 minutes.

Step 3: the cooling proceeded for at the temperature of 0 to 15° C. and the relative humidity of 30% for about 8 minutes and the natural cooling was followed.

Step 4: the pre-dumpling was frozen rapidly at the temperature of −25° C. for about 2 hours to be packed, and the dumpling was stored in a freezer compartment.

The produced dumpling corresponds to a kimchi dumpling.

### Example 2

A Szechuan dumpling was produced by the same process except that the stuff of the bun stuffing was as following:

203.2 g of pork; 118.0 g of glass noodle; 81.8 g of sliced shiitake; 45.1 g of onion; 25.1 g of tofu; 24.8 g of dried radish; 23.4 g of cabbage; 13.2 g of leek; 2.4 g of potato starch; 14.5 g of pepper taste oil; 10.9 g of garlic; 3.2 g of black pepper; 1.1 g of soy sauce; and 0.3 g of flavoring oil.

### Example 3

A large size of meat dumpling was produced by the same process except that the stuff of the bun stuffing was as following:

209.0 g of pork; 118.0 g of glass noodle; 81.6 g of sliced shiitake; 45.1 g of onion; 25.1 g of tofu; 24.8 g of dried radish; 23.4 g of cabbage; 13.2 g of leek; 8.0 g of chives; 2.4 g of potato starch; 2.6 g of winter-grown vegetable; 10.7 g of garlic; 3.1 g of black pepper; 1.1 g of soy sauce; and 0.3 g of flavoring oil.

### Example 4

A dumpling was produce by the same method as example 1, except that the pre-dumpling was cooled only naturally.

### Example 5

A dumpling was produced by the same method as example 2, except that the first cooling proceeded in the condition of 0.8 atmosphere pressure.

### COMPARISON

### Comparison 1

A dumpling was produced under the same condition as example 1, except that the wheat farmed in foreign was used for the skin, substituting for the wheat farmed in domestic.

### Comparison 2

A dumpling was produced under the same condition as example 2, except that the wheat farmed in foreign land was used for the skin, substituting for the wheat farmed in domestic land.

### Comparison 3

A dumpling was produced under the same condition as example 1, except that the pre-dumpling was fermented at the temperature of 40° C. and relative humidity of 70% for about 10 minutes at step 2, and was steamed for about 10 minutes.

### Comparison 4

A dumpling was produced under the same condition as example 2, except that the pre-dumpling was steamed at the temperature of 110° C. for 25 minutes, at step 2.

### Comparison 5

A dumpling was produced under the same condition as example 3, except that the pre-dumpling was frozen rapidly at the temperature of −10° C. for about 2 hours, at step 4.

### RESULT

For testing the effect of the method according to the present invention, dumplings that had been stored in a freezer for ten days lay at the temperature of 20° C. for 1 hour, and then was cooked in a steamer. The steamed dumplings were tested in weight, hardness of the skin and stability. For testing the hardness and the stability, a texture analyzer was used. For testing organic functions, some dumplings and other dumplings had been stored for ten days and for twenty days, respectively, and then the dumplings were taken to be grilled. The test of organic functions was performed in tenderness, wetness, taste and appearance to twenty testers, and for comparison, the average was estimated from 0 to 10 degree.

TABLE 1
Degree of variation of weight, hardness and stability

| | Weight | | Hardness | | Stability | |
|---|---|---|---|---|---|---|
| | before | After | before | after | Before | After |
| exp1 | 101.9 | 108.9 | 10000 | 6411 | 1.00 | 0.41 |
| exp2 | 102.8 | 109.7 | 10021 | 6321 | 0.98 | 0.40 |
| exp3 | 103.1 | 110.4 | 10022 | 6239 | 0.92 | 0.50 |
| exp4 | 101.9 | 108.9 | 10031 | 6372 | 0.98 | 0.49 |
| exp5 | 101.8 | 108.6 | 10017 | 6328 | 0.97 | 0.47 |
| com1 | 101.8 | 108.4 | 10018 | 8728 | 0.99 | 0.65 |
| comp2 | 102.4 | 104.9 | 10023 | 8831 | 0.92 | 0.67 |
| com3 | 103.1 | 103.2 | 10019 | 8749 | 0.96 | 0.76 |
| comp4 | 101.7 | 102.6 | 10021 | 8871 | 0.97 | 0.81 |
| comp5 | 101.4 | 104.1 | 10030 | 8858 | 0.95 | 0.80 |

The value of weight compared with the original weight is illustrated, and the relative hardness compared with example 1 and example 2 is illustrated. The lower the value is, the weaker is the skin. And stability compared with the value of example 1 is illustrated. And the value is lower, the weaker stability is.

TABLE 2
Test of organic functions

| | softness | | wetness | | taste | | appearance | |
|---|---|---|---|---|---|---|---|---|
| | 10 d | 20 d | 10 d | 20 d | 10 d | 20 d | 10 d | 20 d |
| exp1 | 9.2 | 8.9 | 8.9 | 8.1 | 9.2 | 8.8 | 9.1 | 8.8 |
| exp2 | 9.3 | 8.8 | 8.7 | 7.9 | 8.9 | 8.7 | 8.4 | 8.1 |
| exp3 | 9.0 | 9.1 | 8.4 | 7.4 | 8.2 | 7.7 | 8.2 | 8.2 |
| exp4 | 9.4 | 9.0 | 8.8 | 7.3 | 9.5 | 9.4 | 8.7 | 8.5 |
| exp5 | 9.3 | 9.0 | 8.6 | 7.8 | 8.9 | 8.6 | 8.5 | 8.4 |
| com1 | 9.1 | 7.4 | 7.4 | 5.6 | 8.2 | 7.2 | 8.9 | 8.1 |
| com2 | 9.3 | 7.1 | 7.6 | 4.8 | 8.5 | 7.1 | 8.9 | 7.0 |
| com3 | 9.2 | 6.3 | 6.9 | 4.2 | 7.2 | 4.6 | 7.8 | 5.0 |
| com4 | 9.1 | 5.6 | 6.2 | 3.8 | 7.6 | 4.8 | 8.1 | 4.9 |
| com5 | 9.8 | 6.1 | 6.7 | 4.9 | 7.3 | 4.6 | 7.8 | 4.0 |

Each value illustrates the average of 16 measurements except 2 highest values and 2 lowest values.

Seen from the result, the dumpling according to the present invention can be stored for long term. In particular, if produced in condition of lower pressure and a plural stage of cooling, the organic functions are shown as excellent.

While the embodiments of the present invention have been described, it will be understood by those skilled in the art that various modifications and variations are possible without changing the essential features of the invention. Therefore, it should be noted that the forgoing embodiments do not serve to limit the invention but are set forth for illustrative purposes. The scope of the invention is defined by the appended claims, and all variations or modifications or their equivalents made within the meanings and scope of the claims should be construed as falling within the scope of the invention.

1. A method for producing a dumpling comprising:
preparing a pre-stuff by inserting a stuffing into a skin;
fermenting the pre-stuff at a temperature of 30 to 50 □ and a humidity of 50 to 70%;
making a pre-dumpling by steaming the pre-stuff at a temperature of 90 to 130 □ for 5 to 20 minutes;
cooling the pre-dumpling; and
freezing the pre-dumpling to a temperature below −20 □ for about 60 to about 180 minutes,
wherein the skin comprises wheat flour, yeast, water, baking powder, soy bean, and salt.

2. The method of claim 1, further comprising a step of subjecting the wheat flour to heat and a kneader for making gelatinized dough.

3. The method of claim 1, wherein the components of the skin are mixed in two stages.
